(19) United States
(12) Patent Application Publication
(10) Pub. No.: US 2015/0012563 A1
(43) Pub. Date: Jan. 8, 2015

(54) DATA MINING USING ASSOCIATIVE MATRICES

(71) Applicant: SpeedTrack, Inc., Yorba Linda, CA (US)

(72) Inventor: Jerzy Josef Lewak, Del Mar, CA (US)

(73) Assignee: SpeedTrack, Inc., Yorba Linda, CA (US)

(21) Appl. No.: 14/325,251

(22) Filed: Jul. 7, 2014

Related U.S. Application Data
(60) Provisional application No. 61/842,988, filed on Jul. 4, 2013.

(51) Int. Cl. G06F 17/30

(52) U.S. Cl. CPC G06F 17/30539
USPC 707/776

(57) ABSTRACT

A method of mining frequent items in data is described. Categorical associations between elements of data are the core of information contained in the data and are all that is needed to perform data mining. These associations are extracted from data and held in optimized associative matrices whose structure is independent of the nature and structure of the data. All data mining operations and discoveries can be performed using only these associative matrices which provides many advantages over present methods. It allows real-time interactive navigation through the information in the data, enables efficient automatic and user guided determination of the most highly correlated data components, and a winnowing navigation through a large number of automatically determined associations, as for example frequent item sets, amongst which the needle-in-the-haystack may be more easily found.

### CROSS REFERENCE TO RELATED APPLICATIONS

This application claims the benefit of the filing of U.S. Provisional Patent Application No. 61/842,988, filed on Jul. 4, 2013, the disclosure of which is incorporated by reference herein.

### BACKGROUND OF THE INVENTION

Current data mining methods have evolved over the years by assuming that the data are stored in a relational database. Such methods therefore focused on developing and optimizing analysis of data by analyzing records. Numerous methods have competed for optimum performance on the basis that data records will need to be searched and analyzed in the process.

One may distinguish between data and information which the data conveys. Information is conveyed by the categorical association of data elements. For example, in a structured database comprising a set of records, the field values carry very little if any information when they are taken out of context of a record. The context of each field value within the record implies its categorical association with the field name, with other field values in the same record, and with field values in other records. This association carries the information. Similarly in an unstructured database of documents, each document comprises a few loosely structured parts and the context, or proximity of each part to other parts is what conveys the essence of information. Each word in the document on its own contains little if any information. However, the words contained in a sentence, even without regard to their order, carry considerably more information.

Such categorical associations in data can be statistically analyzed to determine statistical associations and estimates of the correlation measures. That is an important part of data mining and is one focus in this invention.

A statistical association example, often used to illustrate data mining in a database of product sales transactions, is the discovery of products purchased together. It amounts to the determination of the products which are statistically associated with each other in data of purchase transactions.

Current methods of determining associations in data require passes through all the records. In some cases several such passes are used. This leads to relatively long, slow performing tasks. Indexing methods make the process faster, but usually not sufficiently fast for real-time ad-hoc association mining of big data.

Interesting, significant statistical and categorical associations may be missed completely, because support or confidence is below the minimum set and setting those too low leads to longer calculation times and sometimes too many results.

### BRIEF SUMMARY OF THE INVENTION

Aspects of the invention provide computer implementations of methods of determining statistical association measures in data. Some aspects of the invention improve the process of data mining, and some aspects of the invention enable users to guide the process of discovery of interesting information in the data.

These and other aspects of the invention are more fully comprehended upon review of this disclosure.

### BRIEF DESCRIPTION OF THE FIGURES

FIG. 1 is a Venn diagram showing logical relationships between frequencies of two selectors.

FIG. 2 is a flow chart of a process useful in an evaluation of results of a query comprised of a conjunction of selectors.

FIG. 3 is a flow chart of a process useful in an evaluation of results of a query comprised of a disjunction of selectors.

FIG. 4 is a flow chart of an example method of determining an association between two selectors or queries comprised of selectors.

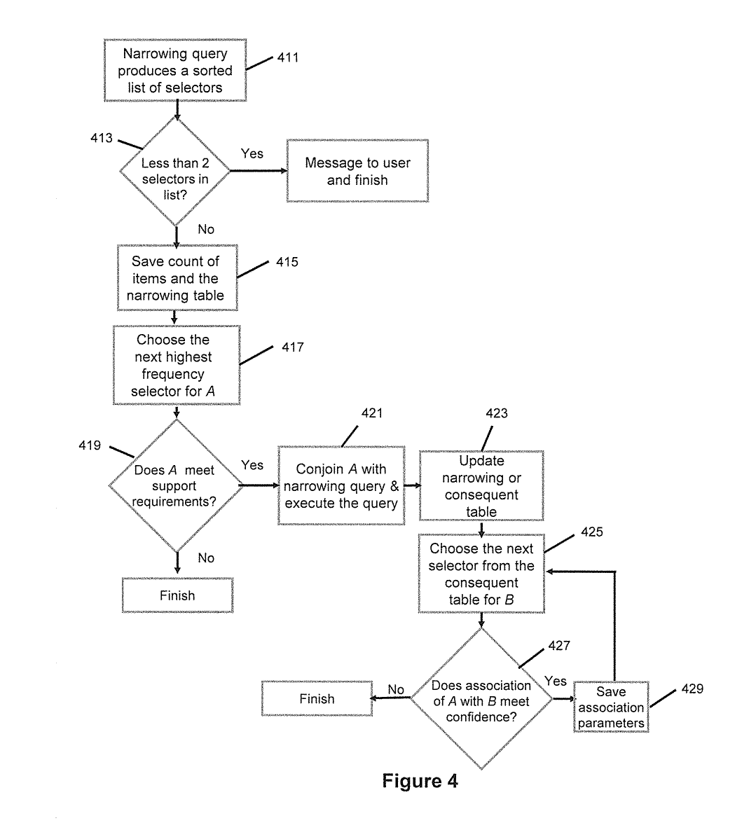

FIG. 5 is a flow chart of a process useful in an evaluation of statistical associations of multiple lengths, using the example method repeatedly.

### DETAILED DESCRIPTION

Methods describe here a different approach to discovery of information in data. This approach, called Mining Associative Matrix (MAM), relies on the extraction of all useful categorical associations present in the data, their storage in optimized matrix-like data structures called Association Matrices, and optimization of methods of determining categorical associations and measures of statistical association using these Association Matrices.

In MAM, navigation through associations allows interactive, real time choices from all possibilities and enables a user to see the interesting categorical associations, inferring from them the statistical associations, both positive and negative, thus enabling the process of user guided data mining. In addition a very large set of pre-calculated associations, can be stored as an additional database, and can be easily navigated by a user to find that “needle-in-a-haystack” association of interest.

This approach opens up many possibilities, such as automatic discovery of the statistical associations with the highest measure of association, that is the discovery of the most associated data components, the interactive, real-time navigation through associations, and user mediated discovery of interesting information.

The method evolved out of and is based on a generalization of Faceted Metadata Search, or Faceted Navigation and is a continued evolution of Technology for Information Engineering or TIE.

In a relational database, there are usually several tables. The records in these tables usually have key fields dedicated to logical categorical associations between the records. Sometimes special tables are dedicated to these associations. Such logical categorical associations are used to make necessary connections during the execution of SQL queries containing so called joins. These joins are performed in real time and slow down the performance, particularly when the number of records to be searched is large.

Extracting all associations before any queries are executed, makes it unnecessary to use SQL queries or joins. Associations between records are stored by combining joined records into what is here called Items.

For example, in a police database of reported incidents, each Item is an incident and consists of a join of several records. For example: a record for each person involved, each vehicle involved, and one or more records describing each crime. The set of all records needed to describe an incident in sufficient detail, is the incident Item. Additionally a person Item may be defined. It may consist of all records containing personal information, possibly also including records of incidents in which the person was involved. Similarly vehicle Items and crime Items may be defined. Different Items are classified here into Item types. Often it is unnecessary to define more than just a few Item types. Items are defined in an Item file each as a set of references to its component records. Categorical associations between each Item and its field values or selectors are extracted and stored in association matrices. In some embodiments all data mining and all searches are performed only on these association matrices.

During data mining, access to records or Items is generally and in some embodiment never needed. Access to records and Items is used, and in some embodiments only used, when data records are to be retrieved. When creating the association matrices, each individual Item is analyzed. The categorical associations with an Item of all of the field values in records comprising the item, are stored in the association matrices in terms of selectors (generalizations of field values or facet values).

Such an extract of all associations allows us to implement the discovery of interesting categorical and statistical associations much more easily and much more efficiently. It also allows very intuitive user interfaces enabling easy user navigation through all possible associations. The association matrices are optimized for performing the tasks of data mining. Such an optimization is independent of the nature of the data being analyzed. It is equally optimal for structured, unstructured, or a mixture of the two data types.

Association matrices store binary, that is categorical associations between what are called here selectors and Items. A selector may be any component of data. A unique field value may be a selector. Every character in a field value may also be a selector. A description of a field value or its attribute, may be a selector. When a field value is a narrative, each word in the narrative may be a selector. In unstructured data, such as a database of documents, each word in a document is usually a selector. This means that a complete selector set is a type of vocabulary of the database. The description of every part of the data is a Boolean expression comprised of zero or more Boolean operators and one or more selectors.

It is convenient to use, as an abstract concept, a binary matrix which stores the categorical association between each selector, and each Item, or component of an item sometimes called an entity. However an optimum implementation of such a matrix is most often not in terms of bit arrays.

When each Item of every Item type is a single record, all the associations may be stored in a single matrix. However, in relational databases an Item often comprises multiple entities. If Items contain multiple entities of the same kind (such as multiple records of people or vehicles) then selectors describing such entities cannot be stored directly associated with Items because there would be no way to store the association of selectors with the right entity, only with the whole item, and ambiguity of association would result. In those cases, categorical associations of selectors to entities are stored in one matrix (the selector-entity matrix) and categorical associations between those entities and Items are stored in another matrix (the entity-Item matrix). For better performance and flexibility of features, often the direct selector-Item matrix is also used. This matrix stores the direct categorical associations between selectors and Items, bypassing the entity associations. Although the results of using this matrix will contain some association ambiguities, these do not affect the results for which this matrix is used.

In practice, because each matrix is stored as an array of arrays, for fast access using selectors, entities, or Items, each matrix is often stored in two different forms, one a transpose of the other. For example, the selector-to-Item matrix is an array of selector vectors and so provides easy access to Items associated with each selector. Its transpose or the Item-to-selector matrix provides easy access to the selectors associated with each Item. In addition, each matrix associating selectors with either entities or Items, is sometimes split into separate matrices for each selector group, i.e. for each generalized facet type. This allows the determination of counts of Items associated with each selector (selector frequencies) in only those groups in which they are needed.

MAM uses the generalization of what has been termed Faceted Navigation or Faceted Metadata Search. In MAM, facets are generalized to selector groups and facet values to selectors.

The complete vocabulary of selectors is divided into subsets, each subset is a selector group and is usually named descriptively. Some selector groups are facets. For example, a person's sex, age, or height, are often regarded as facets. The words in a document (which commonly belong to the content vocabulary group) or in a narrative field (which commonly belong to the field's vocabulary group) are selectors but would not normally be considered facet values. Similarly, individual characters in a license plate are usually selectors, but would not be considered facet values.

Data mining uses queries. In a GIA system the user interface guides the user to the available queries. That is called Guided Information Access or GIA. One important aspect of GIA is the ability to build a query incrementally. Each selector choice usually winnows down the matches. Guidance is achieved by making available, to the user, only the relevant subset of the selector vocabulary. In MAM the frequency of each available selector is shown and updated after each change in the query. A selector frequency is the count of those Items that are associated with the selector. It is also possible, for selectors in entity groups, to display the number of entities (rather than Items or in addition to items) which are associated with each selector.

Queries are created automatically in response to user choice of selectors. Each selector group has a Boolean property. A selector chosen by a user from a conjunctive group is conjoined with any other selector from the same group and the result is conjoined with the current query. The remaining available selectors in the group, categorically associated with the Items matching the query, are updated to show selectors together with their frequencies. Another way to put this is that only selectors with non-zero frequencies are displayed in a conjunctive group. In contrast, a selector chosen from a disjunctive group is added disjunctively to any previously chosen selector from that group and the result (parenthesized to enforce precedence of operations) is conjoined with the current query. In both cases conjunction with a null set is a replacement of the null set. The available selectors in a disjunctive group are not just those associated with the Items matching the current query, but rather those associated with the Items which match a modified query. The modified query is obtained from the current query by removing from the current query all selectors which belong to the disjunctive group.

A conjunctive group is one in which there exists a subset of selectors, which are called here the multiply associated subset, each member of which is categorically associated with more than one Item. A disjunctive group is one in which no multiply associated subset of selectors exists.

There are occasions when in a conjunctive group some selectors need to be chosen as alternatives, which means disjunctively. This is normally enabled by either a temporary change of the Boolean property of the group to disjunctive by using a modifier key during selection of alternatives. However, the display of available selectors remains unchanged. Any group's Boolean property may be changed by a user, because, during data mining, in some cases the display of available selectors in a disjunctive group needs to be changed to that of a conjunctive group.

When determination of associations is desired in data mining, it is convenient to have each selector in its group sorted by frequency, with the highest frequency first. It is here assumed that all selector groups are sorted that way, with the sorting updated after each additional selector is added to the query. Sorting by frequency is updated after each query and can use the efficient sorting algorithm called count sorting, which is of order N complexity.

In a display of selectors in a group, the frequencies are usually displayed in a column to the right of the selectors' column. Other columns may be arranged to display any calculated values derived from frequencies, selector values and aggregates derived from that column. In a group of numeric selectors, derived calculated values may use those selector values and the calculated values can be presented in any other group's column. Each group can present aggregates derived from the values of frequencies and selector values in that group. The usual ones are: total, average, maximum, minimum, standard deviation, and median. Such calculated values are useful in many instances of data mining.

As an example, the total of the frequency column may be used as a denominator in another column to show the fraction or percentage that each frequency represents of the total.

Frequencies, aggregates, and other calculated values may be based on the results of a current query, or the results of a comparison query whose results are saved by the program. The values based on the comparison query may then also be used in calculations using values based on the current query results. In that way many useful calculated values may be explored by adding selectors to, or removing them from the current query. More generally, a column of values in a group can be calculated from the combination of the results of two or more queries.

It is shown here how the calculations of all association measures are easily and efficiently obtainable from selector frequencies resulting from relevant queries. Also details of some optimized methods of computing the results of queries and the resulting frequencies are described. Using GIA makes obvious, in a relatively simple, systematic procedure, the identification of only those associations which are within the desired limits of minimum support, and minimum confidence.

All statistical associations may be expressed in terms of categorical associations between selectors. These in turn may be expressed in terms of selector and query frequencies. A query frequency is the number of Items matching it. The frequency of the query which would result when a selector is conjunctively added to a current query, is the frequency of the selector.

The determination of associations of selectors in one group will be described in detail. The methods developed for that case may be extended to associations between selectors in different groups by combining the contents of the groups into one virtual or even real group. The same method may be used to determine the associations between selectors in a number of groups, independently of their group membership.

An example method, which may be termed a core method, considers the determination of the association between two selectors, labeled as A, and B. The method and other methods discussed herein are performed, in various embodiments, by one or more processors of one or more computer devices, which may be linked by a network, with results and other information stored in computer memory and/or displayed to a user. The symbols A and B assume values of different selectors. In an iterative process (which may be made recursive) one selector from a list is assigned to be the A selector and the next selector (in order of decreasing frequency) from the list of selectors resulting from the execution of the query matching selector A, to be the B selector. Without loss of generality this means that selectors for assignment to A and B are picked such that the frequency of A, designated as n_{A}, is greater than or equal to the frequency of B (n_{B}). Symbolically n_{A}≧n_{B}. The frequency of the query conjoining A with B will be symbolized as n_{AB}.

The core method may also be used when either A and/or B are each assigned to any Boolean query comprised of selectors. With such replacement, the core method may be applied to determine the statistical association between any sets of selectors combined with Booleans, defining the antecedent query and an additional selector conjunctively added to the antecedent query, defining the consequent query.

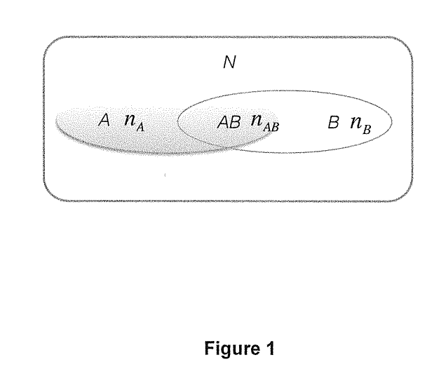

Many different measures of association have been used. The most common ones are support and confidence. There are two ways to express support. One is the support ratio, the other the support count. There are also two expressions for the confidence measure: one is simply called confidence, the other the all-confidence. These and some other measures of association are listed in Table I. The Contingency Frequency Table II shows the relationships which may be used to derive the equations in Table 1 for the various association measures in terms of the frequencies. The contingency table may be derived from a Venn diagram shown in FIG. 1.

Steps of the core method are most easily described and understood by visualizing the display of selectors in a list sorted by frequency, referred to as the available list, with the frequency of each selector. Only available selectors are included in this list, where available selectors are those whose frequencies are not zero. The method assumes that there is a narrowing query (which may be the null query, i.e. no query at all) whose matches narrow the set of Items to a subset on which the association discovery is to be carried out. All queries aimed at association discovery are conjunctively added to this narrowing query. The following method steps assume that following the execution of each query, the list of available selectors with their frequencies is updated and sorted by frequency, highest frequency first. The null query matches all the items and so makes all selectors available. An antecedent query, comprised of one or more selectors conjunctively added to the narrowing query, is executed and its resulting available list is sufficient to determine the support and confidence of every one of the consequent queries, without having to carry them out. The following steps describe details of the core method.

The Core Method
1. The narrowing query produces a list of available selectors with the frequency of each, sorted by frequency, highest first (Block 411);
2. If there are fewer than two available selectors listed in the group (Block 413), end processing and provide appropriate message;
3. Otherwise, save the count of Items matching the narrowing query as N, which is the frequency of the narrowing query (Block 415);
4. And also save a complete frequency-sorted table of selectors in the list with their frequencies, n₁, n₂, n₃, . . . which will be referred to as the narrowing table (Block 415);
5. For A choose the highest (or next highest if this is not the first time this step is being executed) frequency selector from the narrowing table, with frequency referred to as n_{A} (Block 417). If either n_{A} is less than the minimum support count or n_{A}/N is less than the minimum support ratio (Block 419), save all needed data and terminate processing with a suitable message.
6. Otherwise, add selector A conjunctively to the narrowing query and execute the query (Block 421), updating the list of available selectors, their frequencies, and their sorting by frequency and saving the list of selectors and their frequencies in the new narrowing table (or replacing a similar prior table) which will also be called the consequent table (Block 423). Selector A in this table will have the highest frequency.
7. For B choose the next highest frequency selector, taken from the consequent table, its frequency is designated as n_{AB} (Block 425). The frequency of each such available selector represents the frequency that would result from a query with both A and the selector conjunctively added to the narrowing query, however no additional query is needed at this step.
8. Calculate the confidence ratios C_{AB}=n_{AB}/n_{A} and C_{BA}=n_{AB}/n_{B} store only those confidence ratios and the frequencies n_{A}, n_{AB}, n_{AB}, N for associations that exceed the chosen minimum (Blocks 427, 429). With each set of frequencies, save also the set of selector identifiers of selectors A and B.
9. If C_{BA} is less than the desired minimum confidence (which means that both C_{BA} and C_{AB} will be below minimum) go to step 5, otherwise go to step 7.

In this process it is evident that at step 4 associations of the first selector (which has the highest frequency) will have the highest support. So that the order of the selectors in the narrowing table is the order of the supports of the associations of each selector in the list with any other selector.

TABLE I
MEASURES OF STATISTICAL ASSOCIATION

| Measure (Symbol) | Definition |
|---|---|
| Probabilities (P) and support (S) used in | P(A) = n_{A}/N; P(B) = n_{B}/N; AB ≡ A [symbol] B |
| expressions for measures which follow. All | P(AB) = n_{AB}/N; |
| measures may be expressed in terms of only | P(A B̅) = (n_{A} − n_{AB})/N |
| the following 4 frequencies: | P(BĀ) = (n_{B} − n_{AB})/N |
| N, n_{A}, n_{B}, n_{AB} | P(Ā B̅ ) = (N − n_{A} − n_{B} + n_{AB})/N |
| | P(A\|B) = n_{AB}/n_{A} |
| | S(AB) = P(AB); S(A) = n_{A}/N; S(B) = n_{B}/N |
| Support Count | n_{A} |
| Support Ratio | P(A) |
| Confidence | P(A\|B) = n_{AB}/n_{A} |
| All-confidence (h) | $h = \frac{P ( AB )}{Max ( P ( A ) , P ( B ) )} = \frac{{n}_{AB}}{{n}_{A}} , \\ where {n}_{A} \geq {n}_{B}$ |
| Correlation (φ) | $φ = \frac{{Nn}_{AB} - {n}_{A} {n}_{B}}{\sqrt{{n}_{AB} ( N - {n}_{A} - {n}_{B} + {n}_{AB} ) ( {n}_{A} - {n}_{AB} ) ( {n}_{B} - {n}_{AB} )}}$ |
| Odds ratio (α) | $α = \frac{{n}_{AB} ( N - {n}_{AB} )}{( {n}_{A} - {n}_{AB} ) ( {n}_{B} - {n}_{AB} )}$ |
| Yule's Q | $Q = \frac{α - 1}{α + 1}$ |
| Yule's Y | $Y = \frac{\sqrt{α} - 1}{\sqrt{α} + 1}$ |
| Kappa (κ) | $κ = \frac{P ( AB ) + P ( \overline{A} \overline{ B} ) - P ( A ) P ( B ) - P ( \overline{A} ) P ( \overline{B} )}{1 - P ( A ) P ( B ) - P ( \overline{A} ) P ( \overline{B} )}$ |
| Interest (Lift) (I) | $I = \frac{P ( AB )}{P ( A ) P ( B )}$ |
| Cosine (IS) | $IS = \frac{P ( AB )}{\sqrt{P ( A ) P ( B )}}$ |
| Piatetsky-Shapiro (Leverage) (P S) | PS = P(AB) − P(A)P(B) |
| Certainty Factor (F) | $F = max ( \frac{P ( B \vert A ) - P ( B )}{1 - P ( B )} \cdot \frac{P ( A \vert B ) - P ( A )}{1 - P ( A )} )$ |
| Added Value (AV) | AV = max (P(B\|A) − P(B), P(A\|B) − P(A)) |
| Collective strength (S) | $S = \frac{P ( AB ) + P ( \overline{A} \overline{ B} )}{P ( A ) P ( B ) + P ( \overline{A} ) P ( \overline{B} )} \times \frac{1 - P ( A ) P ( B ) - P ( \overline{A} ) P ( \overline{B} )}{1 - P ( AB ) - P ( \overline{A} \overline{B} )}$ |
| Jaccard (ζ) | $ζ = \frac{P ( AB )}{P ( A ) ( P ( B ) - P ( AB )}$ |
| Klosgen (K) | K = \sqrt{P(AB)} AV |

For each such selector used as the antecedent in the pair association, there is a set of selectors in the consequent table, each of which provides the frequency used to calculate the confidence of both the P(A|B)=n_{AB}/n_{A} and P(B|A)=n_{AB}/n_{B}, confidence measures. Because n_{A}≧n_{B}, P(A|B)≦P(B|A), and so is used to check the minimum confidence criterion.

Each query returns the count of matching Items and frequencies of every selector. One query is sufficient for an antecedent selector giving associations with each one of the other selectors as a consequent selector. Results of just one query determine all pair associations of an A selector with every other selector.

Although the above describes the method steps of determining all the associations between a pair of selectors, the same method steps are used to determine associations of a larger number of selectors. The number of selectors in an association subset is referred to as the association length. Calculation of all measures of an association needs only 4 frequencies, as shown in Table 1 for the two selector case. Similarly for an association of any length, only 4 frequencies need be saved. This makes practical the calculation of all potentially useful associations, for example those meeting the minimum criteria, of any length support and confidence limited, in the following way.

In the given steps of the core method, although it was assumed A was a selector, the method may use any Boolean query consisting of selectors in place of A. So for A it may substitute a conjunctive Boolean of any number of selectors. In this way an association of s selectors is used to find the associations of s+1 selectors. After calculating all frequencies needed to measure all associations of two selectors, support and confidence limited, the results are stored in a frequency sorted 2-association list. The core method is re-used but A is picked from the 2-association list and B is picked from the original narrowing list both in order of frequencies. The core method steps will then calculate all frequencies needed for all measures of length 3 correlations. The results are stored in a 3-association list. Then the core method is used again, replacing the previous 2-association list with the resulting 3-association lists, and so on, adding one selector in each use of the core method until the limits of support or confidence are exhausted.

Using The Core Method for Different Association Lengths

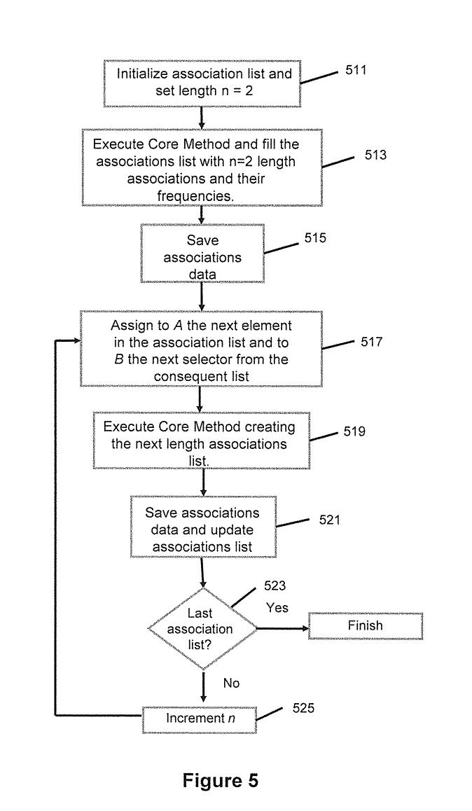

The following, illustrated in FIG. 5, are method steps that can be used to evaluate associations of all useful lengths:
1. Initialize an empty associations list and set the association length n=2 (Block 511).
2. Execute the core method using the narrowing list to pick A and the consequent list to pick B and filling the associations list with 2-selector (n=2) associations, sorted by frequency (Block 513).
3. Save the associations list and frequencies associated with each association (Block 515).
4. Execute the core method using the associations list of n-selector associations from which to pick A and the narrowing or consequent list from which to pick B thereby evaluating the (n+1)-selector associations (Blocks 517, 519).
5. Save the associations list and frequencies associated with each association (Block 521).
6. Replace the associations list elements with the newly calculated (n+1)-selector associations list.
7. If not the last association list (Block 523), increment n (Block 525) and repeat from step 4 until the conditions of support and confidence are no longer possible to meet.

This method may be used to automatically determine all associations meeting predefined support and confidence criteria. This may be a manageable number, though usually it is too large to display to a user.

For example, consider the case of a healthcare database with about 64 million hospital encounters. Consider calculating automatically all the possible associations of diagnoses (without any limits on support or confidence). The maximum number of diagnoses per encounter is 24, but the total number of possible diagnoses is about 13,000. Assuming length 2 association measures and without any limits on support or confidence, a maximum of about 156 million length 2 associations could be supported and could enable a much larger number of different association measures. All this could be achieved with just 13,000 queries.

Such numbers are the maxima possible, but in practice the number of frequency sets needed is very much smaller when reasonable support and confidence limits are set. So for example, in the example healthcare database if 1,000 is chosen as the lowest support frequency, which in the example data happens to correspond to a support ratio limit of 1.56×10⁻⁵, there are about 5,000 selectors which have frequencies of at least 1,000. The calculation would require 5,000 queries giving potentially about 75 million frequency sets. These numbers could be very much smaller if a minimum confidence level was imposed.

Such a large number of associations may be made available for fruitful user examination by using the GIA interface on the determined associations. GIA allows choices from facet values, narrowing the matching associations. One choice may limit the selector set between which the association measures are to be shown. The association length may also be chosen to further narrow the list. Additionally limits of support and confidence may be chosen and finally, if the list is too long, specific antecedent or consequent sets of selectors, representing associations of interest, may be chosen.

Alternatively to the automatic association extraction, the user may choose to calculate particular smaller sets of associations through the GIA interface. A user may first choose and execute a narrowing query. This provides a view of all selectors, sorted by frequency. The user then chooses the highest frequency selector to see all the associated selectors and their association measures of confidence and support.

Using the associative matrices, the methods of executing queries may be optimized independently of the nature of the data. Every query execution determines each selector's frequency and the query frequency, which is the count of matched Items. With a single selector (A) query, this provides the four frequencies (n_{A}, n_{B}, n_{AB}, and N) needed for the association of each selector B with the chosen selector A.

Each row of an association matrix is usually stored as an array whose components are the column numbers of the non-zero cells in the corresponding bit vector. Assuming the use of 32 bit IDs, storing a matrix as a bitmap is more compact only when the matrix is more dense than one in 32 non-zero bits. However, when executing a query it is often more performance optimal to convert a vector being used in the query evaluation process to bit vectors. The following explains a possible set of method steps.

A query typically consists of a set of selectors and a set of Boolean operators. The evaluation of such Booleans, in the simplest cases involves unions and intersections of components of selector vectors, each component is an ID of an Item categorically associated with the selector. So that for example the conjunctive Boolean between selector A and selector B is evaluated and the components of the result vector C are the IDs of the Items matching the Boolean query A and B.

TABLE II
CONTINGENCY FREQUENCY TABLE

| | B | B̅ | |
|---|---|---|---|
| A | nAB | nA − nAB | nA |
| Ā | nB − nAB | N − nA − nB + nAB | N − nA |
| | nB | N − nB | N |

The result vector is then conjoined (or disjoined) with the next selector vector, if any, in the Boolean and the process proceeds in that way.

Next are described some optimal methods of evaluating the conjunction and the disjunction between two vectors.

When the two vectors have components which are sorted indexes of the non-zero bits in the corresponding bit vector form, the common method of evaluating their conjunction or disjunction is the well-known zig-zag method. A method that is faster in performance and does not require the vector components to be sorted is described next.

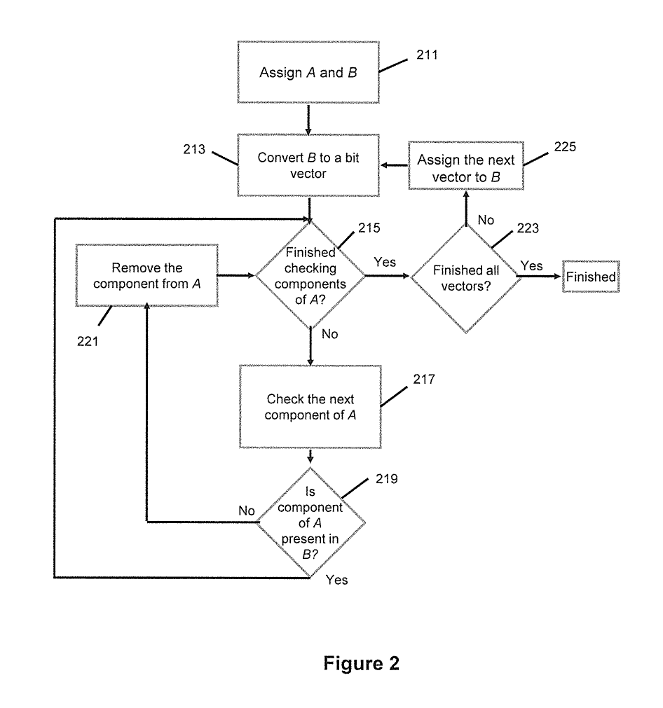

Let the two vectors to be conjunctively combined be A and B both in ID component form. The process is described in term's of A and B in an iterative process and illustrated in FIG. 2. The steps are as follows:
1. Assign the first selector vector (or query result vector) to be vector A and the next selector vector to be vector B (Block 211);
2. Convert B to a bit vector (Block 213) by using each component ID of the ID vector to address the corresponding bit index of a bit vector component and setting it to 1;
3. Iterate (Blocks 215-221) through the ID components of vector A using each component as the index into the bit vector and if that bit component is not a 1, remove the component from vector A;
4. The modified or temporary result vector A is then used with the next vector is assigned to B, to be conjoined with vector A and the process repeated from step 2 until all conjunctions are completed. 5. The resulting modified vector A is the result vector, whose components are the IDs of the matching Items.
6. If not finished with all vectors, take the next selector vector as the new vector B and go to step 2 (Blocks 223, 225).

Usually the conjunctions of only a small number of selectors are needed and since after every additional conjoined selector the number of components of the resulting vector either gets smaller or remains the same, the zig-zag method may be quite satisfactory in performance.

A similar method is used to evaluate the disjunction of a set of vectors. Disjunctions are more often needed to evaluate the available selectors and their frequencies, which often entails a much larger set of vectors (usually Item vectors) to be disjoined. Therefore disjunctions are even more important to optimize. Disjunction of a very large set of Item vectors, to determine the frequencies of all selectors, are often needed. For example, in a database where Items include information about people, sending a query for all males will match about half of the Items, thus requiring the determination of the frequency contributions to all selectors of about half the total Items, a process that is about as long as determining the union set of the selectors associated with half the database.

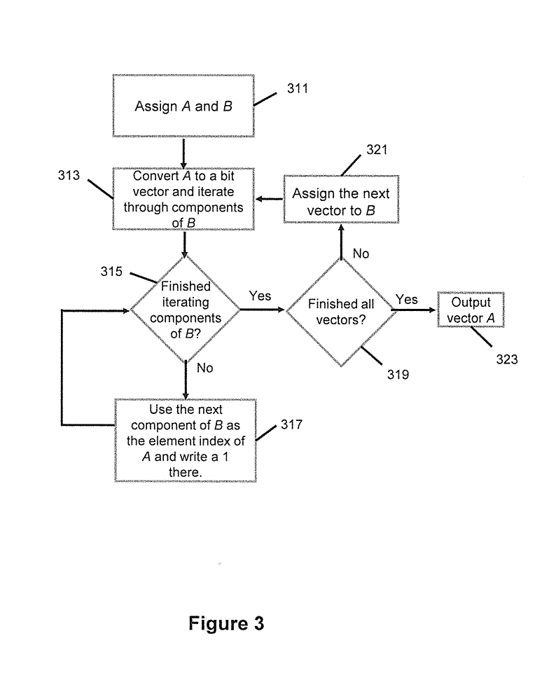

The possible optimized steps, illustrated in FIG. 3, for the determination of the disjunction of two vectors A and B are as follows:
1. Assign the first selector vector or query to vector A and the next vector to vector B (Block 311);
2. Convert A to a bit vector by using each component ID of the ID vector to address the corresponding bit index of the bit vector and setting it to 1 (Block 313);
3. And iterate through the ID components of vector B using each component as the index of the A bit vector and setting it to 1 (Blocks 313-315);
4. Modified bit vector A is then used as the result vector and disjunctively combined with the next vector assigned to B and the process repeated from step 3 until all disjunctions are completed (Blocks 319-321).
5. The resulting modified vector A (Block 323) is the result vector, whose component bits designate the IDs of the union set of the components of all the disjoined vectors.

The following describes steps to determine the counts of Items associated with each selector, these are the selector frequencies.

Once the set of matching Items is determined, the Item-to-selector matrix should be used to determine the selector frequencies. The process steps are very similar to the disjunction steps just described, but instead of using a bit vector for the output vector (vector A) an array of counts vector (more simply referred to as the counting vector) is used for vector A. This is usually an array of integers, each integer large enough to store the largest count of Items and the size of the array sufficiently long to store the counts of all the selectors whose associated Item counts are needed for calculations. Each array index of the counting vector is made the ID of a selector, which allows the addressing of each counting element just like addressing the bit of each bit vector. The steps are the following:
1. Create the counting vector array A, initialize it to the needed size and set all counts to zero;
2. Use the components of the next Item vector as indexes into the counting array and at each addressed index increment the count;
3. Repeat step 2 until all Item vectors matched by the current query have been processed;
4. The resulting counting vector A contains the counts of every selector. Those with zero counts are usually not made available for conjunctive additions to queries.

In MAM several optimizations of query response times are possible. Association matrices usually include the totals of each row and column. The row totals are the number of Items associated with each selector, that is the number of matching Items. The column totals are the number of selectors associated with each Item. The rows may be reordered as long as the identification of each row with a selector is maintained. Similarly the columns may be reordered as long as the identification of each column with an Item is maintained. This allows the sorting of rows and columns by their totals, ending up with the maximum density of ones in the top left corner of the matrix and the density decreasing in both directions from that corner. With such an arrangement, the rows and columns may be implemented as vectors (arrays) more efficiently because of the following. Such sorting usually arranges for neighboring vectors to share a large part of the vectors. So that, for example, two or more neighboring rows may have some number of their first cell values in common. This effect would enable the vectors with common parts to only store that part once, thus saving RAM. This also improves query performance because the common parts of a vector need only be checked once.

Some queries, referred to as long queries, match a large number of Items and the desired determination of frequencies of selectors associated with these is a processor intensive task with attendant response time delays. Conjunctive long queries are easily identified because the longest such queries are single-selector queries and the number of matching Items is the frequency of a selector and so a good indicator of response time. Therefore it is possible to pre-cache such long queries, saving the results for quick responses. Multiple selector conjunctive queries may also include long queries and these too may be identified and pre-cached. Such pre-caching is practical in datasets which are changed infrequently. The pre-caching is usually performed as a background task and/or as a scheduled task during times when the server is not being used. Finally both caches and pre-caches may be used when the associated cached query is part of a current query and this will expedite the response.

### SUMMARY

A new method (MAM) of evaluating associations in data for association discovery was described. The method relies on extracting associations, in some embodiments all associations, and storing them in associative metadata of matrix structures which are preferably optimized for the evaluation of special queries, independently of the nature of the data. Discovery of all associations may be performed entirely in terms of such special queries on the metadata. The results of a single query are sufficient to evaluate all associations of the query parameters with all other individual parameters in the data. This makes practical the evaluation of all associations with desired minimum support and confidence levels.

In most large datasets, the number of possible associations, even when limited by reasonable support and confidence requirements, can be very large, too large to be practical for manual examination. In such cases a special associative metadata can be automatically created to allow user navigation through the database of calculated associations, with the possibility of discovering the interesting associations.

Although the invention has been discussed with respect to various embodiments, it should be recognized that the invention comprises the novel and non-obvious claims supported by this disclosure.

We claim:

1. A computer implemented method of determining statistical associations in data, the method comprising:
extracting, from the data, categorical associations between selectors and data items;
storing the extracted categorical associations in optimized associative structures whose structure is independent of the data item structure or data type;
evaluating the results of a query comprised of one or more selectors, using the associative structures, the results of the query sufficient to determine numerical measures of statistical associations between the data matched by the query and other data components represented by a plurality of other selectors.

2. The method of claim 1 wherein the results of the query include the counts of items associated with each of a plurality of selectors resulting from the query.

3. The method of claim 1, wherein the optimized associative data structures may be logically represented as a set of matrices.

4. The method of claim 1 wherein the query results include the frequencies of a plurality of selectors other than those comprising the query.

5. The method of claim 1, wherein the query is comprised of a conjunction of a plurality of selectors.

6. A computer implemented method of evaluating statistical association measures from data, the method comprising:
extracting, from the data, categorical associations between selectors and data items;
storing the extracted categorical associations in optimized associative structures whose structure is independent of the data item structure or data type;
using associative structures to make available to a user a list of the categorical associations together with frequencies, that is counts of items associated with each available selector;
using the frequencies in the calculation of statistical association measures between available selectors;
making available to a user the calculated statistical associations.

7. The method of claim 6, further using a query comprising selectors to determine the categorical associations.

8. The method of claim 6 wherein the results of the query include the counts of items associated with each of a plurality of selectors resulting from the query.

9. The method of claim 8, wherein the query is comprised of a conjunction of a plurality of selectors.
